(19) United States
(12) Patent Application Publication
(10) Pub. No.: US 2004/0002387 A1
(43) Pub. Date: Jan. 1, 2004

(54) Card reader and scanner device and methods of using same

(76) Inventor: Daniel Patrick Grady, Shiojiri-shi (JP)

Correspondence Address: AUSTIN J. FOLEY, ESQ., WALLENSTEIN & WAGNER, LTD., 53RD FLOOR, 311 SOUTH WACKER DRIVE, CHICAGO, IL, 60606-6630, US

(21) Appl. No.: 10/180,257

(22) Filed: Jun. 26, 2002

(51) Int. Cl. G06F 17/00

(52) U.S. Cl. 463/43

(57) ABSTRACT

A scanner/reader device is provided for use with a card having printed information and information stored on a computer readable medium. The device comprises a housing having a slot adapted for receiving the card with a plurality of pressure sensitive guide rollers adjacent the slot. An optical scanning unit is mounted within the housing for detecting the printed information and a chip reading unit is mounted within the housing for detecting the information stored on the computer readable medium. A logic board is mounted within the housing for controlling the rollers, the optical scanning unit and the chip reading unit and the device includes an output port for outputting information detected by the optical scanning unit and the chip reading unit.

### DESCRIPTION

1. Technical Field

The present invention is related generally to trading card fantasy games. More specifically and without limitation, it relates to improved methods of playing a trading card game and to an improved card scanner and reader device and methods of using same.

2. Background of the Invention

Playing card games have long been known in the industry. For example, a standard deck of cards utilized to play games such as poker, bridge and the like traditionally consists of fifty-four cards—thirteen spades, thirteen hearts, thirteen clubs, thirteen diamonds and a pair of jokers. In most games, such as the various forms of poker, blackjack, hearts and the like, one deck is shared among a number of players playing a single game. Typically, a dealer, perhaps one of the players, deals a number of the cards to each player and the game proceeds according to a known set of rules.

Another type of card game that has recently become very popular is called a “trading card game.” There is a wide variety of trading card games currently available, each of which is played according to its own set of rules. However, each type of game shares the following general characteristics.

In contrast to the traditional playing card games, in trading card games, each player plays the game with their own unique collection of tradable playing cards or trading cards. Players collect cards in much the same way that people have been collecting baseball cards for generations. The creator or manufacturer of the game prints and distributes the cards. The cards are typically grouped together in a package with other cards. The packaging is such that the collector or player cannot identify what individual cards are included in a pack before purchasing them, and each pack is comprised of a generally random variety of cards. In this way, each player compiles a generally unique collection of playing or trading cards by purchasing these packets. Additionally, a player may bargain for and trade cards with other players. Each type of card within a game has a unique set of parameters that defines the effect of the particular type of card within that game. The manufacturers issue the more effective or useful cards in a smaller frequency and quantity than the less effective or less useful cards. This creates a hierarchy of cards and obviously makes the more effective cards more rare and valuable than other cards.

Through this process, players develop their own individual deck according to various factors. One of these factors is the player's ability and willingness to barter, negotiate and trade cards with other players. Another factor is the amount of money a player is willing to spend on collecting or creating their own individual deck of cards. Much of the success of these trading card games is owed to the appeal of the process involved in creating one's individual collection of cards.

Prior to playing a game, each player chooses cards from their unique collection to form a deck of cards with which to play a game. As indicated, each card has printed on it an ability point or strength rating for at least one of a variety of game parameters. Cards can include offensive and defensive ratings, ratings for effectiveness of use of particular weapons or can include ratings for any of a number of other game parameters. Additionally, a card could include an additional parameter indicating that the card's character is capable of performing some magic or special effect (such as morphing, teleporting or the like). Accordingly, much skill in the form of strategy is involved in choosing a deck. The deck should be constructed according to the player's individual style or strategy of play. It should also take into account the player's assessment of the contents, strengths and weaknesses of opponents' card collections. Such an assessment of the construction of an opponent's collection is generally based in part on speculation as well as on information learned during the trading process.

In playing the game, each player draws a card or cards from their deck, usually randomly. The card(s) is placed on a playing field for a head-to-head battle with a card placed on the playing field by an opponent. The game proceeds according to the rules of the particular game and the various parameters and ability of each card. This overall process is played in rounds and repeated until a winner is declared according to game rules.

More recently, trading card games have become computerized with manufacturers offering electronic versions. In these electronic versions, manufacturers create electronic playing cards that are based on trading and that are saved in a computer storage medium. Each e-card is saved in its own file to a computer disk and has a locking/unlocking script associated therewith. The script restricts copying and provides authenticity, but the script also tends to disallow or prevent trading of these cards on a large scale. Even those types of electronic cards that can be traded and copied in a controlled manner and that also maintain the integrity of the game and maintain the manufacturer-chosen balance of the game, tend to be too expensive or unpopular to create interest in the trading-card world. The game may then be played against a computer opponent, against another opponent using the same computer, or against an opponent at a remote location. However, those interested in participating in these electronic versions of the trading card games are often the same individuals who participate in the traditional paper card based trading games. The electronic versions ignore the time, effort and money invested by players in their paper trading card collections. Also, purchasing and trading of electronic or virtual trading cards has not generated as much interest as has the purchasing and trading of paper or real trading cards.

U.S. Pat. No. 5,810,666 discloses a trading card game similar to that generally described above. Each trading card of the game disclosed in the '666 patent is individually numbered by the manufacturer to make each card unique. In one embodiment of the '666 patent, the individual number of each card is utilized to access a card's abilities or point values to enable on-line play. This embodiment of the '666 patent, however, has the cumbersome and cost intensive requirement that a master database be maintained containing the ability characteristics of each individual card. This database must be accessed each time an on-line game is begun and a card is played. Additionally, similar to the electronic versions discussed above, the game of the '666 patent ignores or wastes the time, effort and money invested by players in their already collected paper trading card collections.

Additionally, security identification cards as are commonly used to gain access to restricted areas, may include a photograph of an individual having authorization to access the restricted area. They may also include a computer chip or other electronically readable medium containing authorization information allowing the holder of the card access to the restricted area. Typically, the card is subjected to two checks. The first is a visual check by security personnel who compare the photograph to the individual presenting the card. The second check typically involves swiping the card through a reader that detects the authorization information stored on the card and compares it to information stored in a database. There is currently no means available, however, to link the photograph on the card to the information stored on the computer readable medium.

For example, if one were to obtain a stolen security card with active authorization information stored thereon, the picture of the authorized person could be replaced with that of an unauthorized person. Given the state of today's technology, this could be done such that the alteration was not noticeable to the security personnel performing the visual check, allowing unauthorized access to a restricted area.

In a new field of security called biometrics, new types of identification and verification techniques are being developed including facial recognition and finger-printing. Although these technologies are generating much interest, they are still in early stages of development. Facial-recognition programs have a high rate of misidentification and even a 1% mis-ID rate will cause havoc at businesses, airports, and other locations. Finger-printing is also a promising technology but many people are adverse to entrusting their personal data and fingerprints to governments and businesses. Neither of these technologies fill the current or near future security needs by themselves.

The present invention is provided to solve these and other problems.

### SUMMARY OF THE INVENTION

A scanner/reader device is provided for use with a card having printed information and information stored on a computer readable medium. The device comprises a housing having a slot adapted for receiving the card with a plurality of pressure sensitive guide rollers adjacent the slot. An optical scanning unit is mounted within the housing for detecting the printed information and a chip reading unit is mounted within the housing for detecting the information stored on the computer readable medium. A logic board is mounted within the housing for controlling the rollers, the optical scanning unit and the chip reading unit and the device includes an output port for outputting information detected by the optical scanning unit and the chip reading unit.

### BRIEF DESCRIPTION OF THE DRAWINGS

The improved card scanner/reader device of the invention will now be described with reference to the accompanying drawings, in which:

FIG. 1 depicts an improved trading card;

FIG. 2 depicts an improved card scanner/reader device;

FIG. 3 depicts a PC/game machine for use with the device of FIG. 2;

FIG. 4 depicts a side view of a trading card chipper;

FIG. 5 depicts a side view of a chipper tray in an open position;

FIG. 6 depicts a side view of a chipper tray in a closed position;

FIG. 7 depicts a top view of the chipper tray of FIG. 5;

FIG. 8 depicts a chip pouch for use with the chipper of FIG. 4;

FIG. 9 depicts a security card for use with the card scanner/reader device of FIG. 2;

FIG. 10A is a side view of a multi-card scanner/reader device for use with game play; and

FIG. 10B is an end or front view of the multi-card scanner/reader device of FIG. 10A.

### DETAILED DESCRIPTION OF THE PREFERRED EMBODIMENT

While this invention is susceptible of embodiment in many different forms, and will herein be described in detail, preferred embodiments of the invention are disclosed with the understanding that the present disclosure is to be considered as exemplifications of the principles of the invention and are not intended to limit the broad aspects of the invention to the embodiments illustrated.

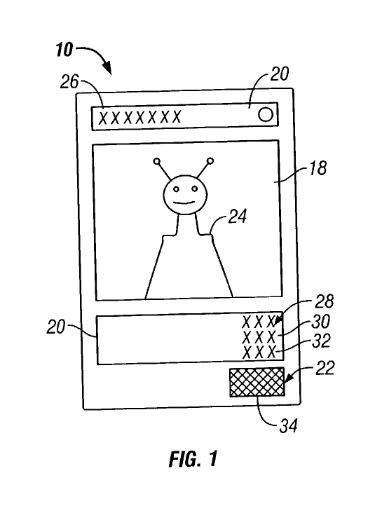

FIG. 1 shows a collectable trading card 10 of the improved trading card fantasy game of the present invention. Similar to the traditional trading card games described above, a manufacturer of the improved trading card game of the present invention manufactures a large number of the trading cards 10 of various types. Each type of card 10, only one of which is shown in FIG. 1, generally includes a graphics area 18, a printed data field 20 and a computer readable medium 22.

The graphics area 18 includes a picture or graphic representation 24 of a character of the particular game being played. The character 24 displayed in graphics area 18 will generally be designed to correspond to the various properties and abilities of the character 24 as listed elsewhere on the card 10 and as described below. This visual or graphic representation 24 in graphics area 18 assists in giving each card type its own unique identity. It also enhances the trading aspects of the trading card game to provide stimulating and unique graphics on each of the trading cards 10.

The printed data field 20 displays in a human readable format, all pertinent data with respect to the character 24 displayed in the graphics area. This may include, among other things, the name 26 of the character 24 and various performance parameter data 28. The performance parameter data 28 may include at least one ability 30 and corresponding strength ratings 32 for each listed ability 30. The pertinent data for a particular character is ultimately determined according to the rules of a particular game.

The computer readable medium 22 of the card 10 depicted in FIG. 1 is in the form of an integrated circuit computer chip or static-memory chip 34, also commonly known as a “smart chip”. Stored in a readable format on the chip 34 is the identical data that is contained in the printed data field 20. Additionally, the chip 34 may include card-authenticating information and unique information or functionality such as password protection, as well. It should be noted, that although not shown in the figures, card authenticating information may be included in the printed data field 20.

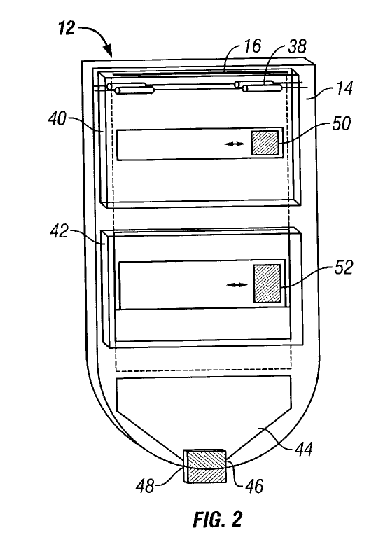

FIG. 2 depicts a card scanner/reader device 12 for use with the present invention. The scanner/reader device 12 includes a housing 14 having a slot 16 for receiving a card 10 and pressure sensitive guide rollers 38 adjacent the slot 16. Also enclosed within the housing is an optical scanning assembly 40, a chip reading assembly 42 and a CPU or logic board 44. The scanner/reader device 12 also includes a connector 46 comprising an input/output port 48.

The scanning assembly 40 includes a scanner 50 and a drive mechanism (not shown) for lateral movement of the scanner 50, as shown. The chip reading assembly 42 includes a reader 52 and a drive mechanism (not shown) for lateral movement of the reader 52 as shown. The reader 52 is capable of both reading information from the computer readable medium 22 and saving information to a computer readable medium 22.

The logic board 44 controls the operation and function of the guide rollers 38, scanning assembly 40 and reading assembly 42. The logic board 44 is also in communication with the scanner 50 and reader 52. The logic board 44 is also capable of communicating with other devices via the input/output port 48 and may have various types of software stored thereon.

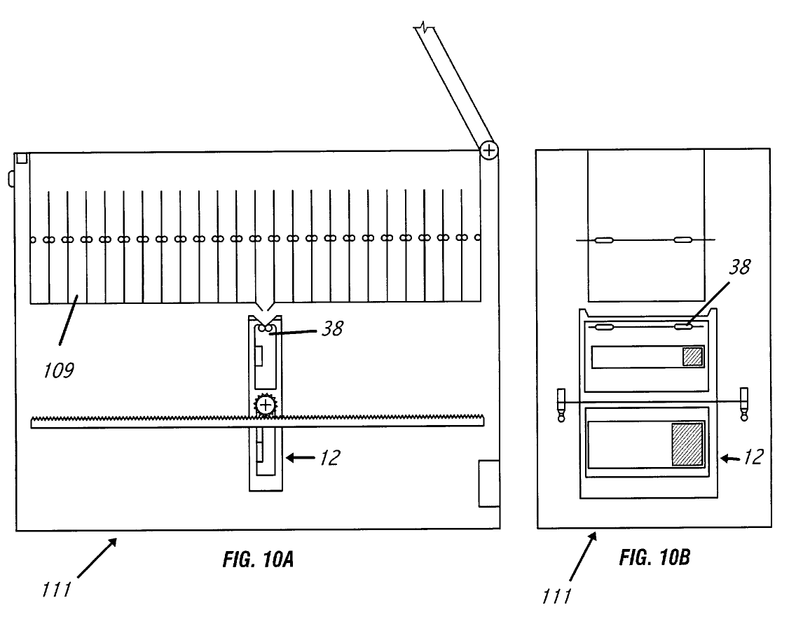

Alternatively the scanner/reader 12 may be included in a multiple card holder/scanner 111 shown in FIG. 10. The multiple card holder 111 includes a series of slots 109 positioned above the scanner/reader 12, to be more fully described below.

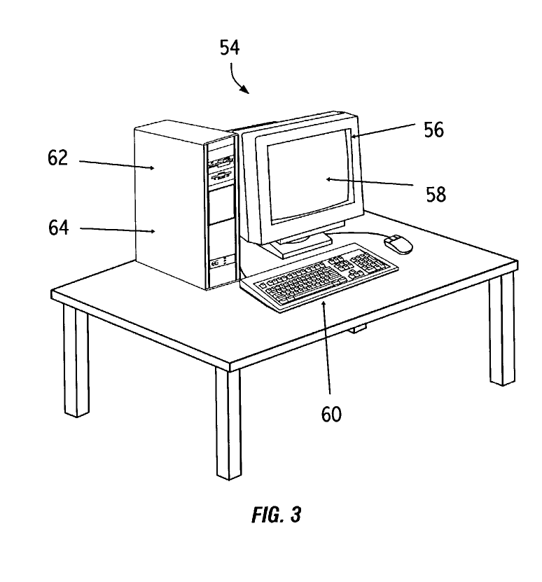

The personal computer or game machine 54 of FIG. 3 includes a display 56, various input means, which may comprise a portion of a touch sensitive screen 58, or a keyboard 60, a CPU 62, game engine 64, various input ports or receivers (not shown) and various output ports or transmitters (not shown). The display 56 and input means 58,60 together form a part of the game machine's interface that allows a human to interact with the computer 54. The various input ports also allow data to be uploaded to the personal computer from other devices/locations, as described below. The game engine 64 includes game software that is executed and run by the CPU 62. The game machine 54 receives data, such as performance parameter data 28, through its various input ports. When executed by the CPU 62, the game engine 62 permits a user to play a trading card game according to the inputted performance parameter data 28, as more fully described later. The output ports or transmitters allow the game machine 54 to be connected to other game machines 14 or to a computer network 16. This computer network 16 may include the internet.

To play the improved trading card game of the present invention, a player would first spend enjoyable and challenging time building up a collection of various trading cards 10. This can be done in ways similar to those described above. Once the player has a large enough collection, the player will choose a predetermined number of cards 10 from the collection to form a deck from which to play a game. The player will then generally load the cards 10 of the chosen deck utilizing the loading/storing device (FIG. 10), which automatically scans the cards using the scanning/reading device 12 to identify and verify them optically and/or electronically.

The card 10 is scanned/read by inserting the card 10 into a slot 109 (FIG. 10) which acts as a holder for the card. Once the cards to be played have been loaded and the lid shut, play begins along with scanning. As the logic determines that a card in a certain slot 109 (i.e. slot 23 of 56) must be scanned, the scanning device 12 moves to align with that slot, the catch opens electronically to release the card, and the card enters the scanning device 12. As the card enters the slot 16, it comes into contact with the pressure sensitive rollers 38, which cause the rollers 38 to activate to advance the card 10 to the reading and scanning position inside of device 12.

A card 10 is fed forward using the rollers 38 and the logic board 44 determines when the card 10 has reached the start of scan position via fixed start of scan sensor (not shown) or a combination of entry sensors (i.e. pressure sensitive rollers 38) and a predetermined distance value measured in revolutions of the rollers or roller motor. Once the card 10 is in the scanning or start of scan position, the optical scanning assembly 40 makes a series of passes over the card 10 in a lateral direction, scanning the data contained in the printed data and image fields. The logic board converts the scanned data to digital information using OCR, analog-to-digital converters, unique color profiles provided by card manufactures/software maker/third-party, and then stores this data temporarily in internal memory.

Once the card 10 is in the chip reading position (i.e. where a smart chip's contacts come into contact with the reading device's contacts), the chip reading assembly 42 reads the performance parameter and card authentication information contained thereon, and communicates said information to the logic board. In these types of cases the position of the integrated chip on the chip strip will vary to protect the aesthetic properties of the card, and in this case the reading assembly 42 will move laterally to match the lateral position of the integrated chip. The position information is garnered from card-profile data which mat be stored on a game CD-ROM, online site such as third-party game site, or from color codes or bar codes (not shown) printed directly on a leading corner of the chip-strip pouch.

Once the necessary information has been detected from the card 10 by the scanner/reader device 12, the logic board 44 operates the guide rollers to eject the card from the scanner 12 back through the open catches 109 and into the corresponding holding slot 108. Also, the logic tracks which card is in which particular slot, so a card does not need to be verified again until the power is turned off or the lid opened. The device feeds the card 10 back into the device 12 to update parameter data according to the flow of game play or the player's decision to save the game and game data at that particular point.

The logic board 44 then compares the character identification information obtained by the scanner 50 to the character identification and authentication information obtained by the reader 52, to verify integrity of the card being scanned. The logic board 44 then saves the information obtained by the scanner 50, by the reader 52, and the results of the integrity check, to its temporary memory. This information is then communicated to the PC or game machine 54 via the device's input/output port 48 via known communication means. These means may include a physical connection or wireless or infrared communication.

The information communicated to the PC or game machine 54 may be stored in internal memory (not shown) of the game machine 54 or it may be stored to a portable memory medium (not shown) associated with the game machine 54. As would be known to anyone of ordinary skill, cards 10 could be similarly scanned utilizing the stand alone scanner/reader device of FIG. 2.

Players then run the game engine 64 through the touch screen 58 or keyboard 60 provided and utilize the game machine 54 to play the trading card game utilizing the cards 10 chosen from their own collection. The game may be played in a number of manners utilizing the described improved method. First, the player may pit his own collection of cards 10 against the game machine 54 by playing against the game software loaded into the game engine 64. Players may also connect their game machine 54 to those of other players and play the trading card game in a virtual world as dictated by the game engine 62, utilizing their own real world collection of cards 10. This connection to other game machines 14 may take place in many forms. It may be a direct connection between two game machines 14, it may be two players sharing one game machine, or it may be a connection between two or more game machines 14 utilizing a modem and known communication technology to play against a remote player. Of course, this connection could include known connections to the internet or other computer networks 16 thereby enabling limitless virtual play of the trading card game using one's real collection of trading cards 10.

The above-described embodiment may take several forms and include several variations while remaining within the scope of the present invention. For instance, the computer readable medium 22 may take many forms, including all forms of IC computer chips, so long as the medium is readable by a scanner, reader or other device. The dimensions of the device, scanning/reading path, and the chip-strip or other pouch may vary to accommodate a wide variety of trading cards and similar valued items. It may also take the form of bar coding, in which case the reading assembly 42 would include a bar code reader rather than a chip reader 52. Furthermore, the cards 10, may not even include a computer readable medium 22 separate from the printed data field 20. In this instance, a scanner 50 utilizing optical character recognition software technology would be utilized to read the data from the card 10. In this instance, any card-authentication information 36 would also be readable by the scanner 12.

A further variation would include combining the scanner/reader device 12 and the game machine/PC 54 into a single device. A further variation on the described invention would be to replace the step of scanning the cards 10 with manual entry by the player of the needed data directly into the game machine/PC 54 via the provided input means.

Additionally, the software used to control scanning and reading may include trading card or chip strip profiles which enhance the accuracy and speed of the device and associated functions. A profile is pre-made physical and optical parameters that describe the horizontal and vertical positions of the printed data and image fields as well as the position of the integrated chip on the chip strip pouch. Moreover, these profiles will include color information to be used in manipulating the RGB thresholds used in scanning. This color information will tell the scanner how to adjust or correct the standard filters so that background colors will not decrease scanning accuracy.

It is also noted that no card-authenticating data need be provided or utilized. However, in this instance, there would be an increased risk of attempts to play cards 10 virtually that are not actually in the possession of the player or to play counterfeit cards. Also, rather than scanning the chosen deck of cards 10 at the time of play, a player may choose to scan the entire collection of cards 10 and save the inputted information in a database, or otherwise, on the game machine/pc 54 or on a portable memory storage medium associated with the game machine 54. However, in some embodiments, the game engine 62 software would then require the cards 10 that are attempted to be played to be scanned again to verify their possession by the player.

Each of these variations, alone or in combination, could be utilized without departing from the scope of the present invention that allows paper or real trading cards 10 to be played remotely on a virtual playing field.

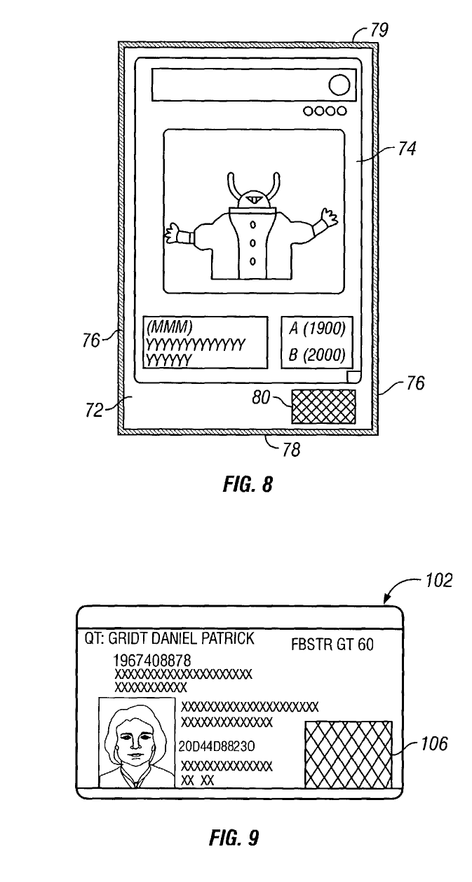

An additional embodiment will now be described that may be used by manufacturers or others to enable existing traditional paper trading cards, not having a computer readable medium 22, to be played on the virtual field. FIGS. 4-7 show a trading card chipper 70 and FIG. 8 shows a chip strip, holder, or pouch 72 having a traditional trading card 74 (without a computer readable medium) and a smart chip 76 associated therewith.

The pouch 72 is comprised of a transparent flexible plastic material that is melt-able for sealing purposes. The pouch is sized to sealingly enclose and encase a traditional trading card 74. As provided by the manufacturer, the pouch 72 is sealed along both sides 76 and its bottom 78 edges. Its top edge 79 is left open to allow access to the interior of the pouch 72. An end user inserts a traditional trading card 74 into the pouch 72 for permanently associating the traditional trading card 74 with the pouch 72, as described below.

As provided by the manufacturer, the pouch 72 also has a smart computer chip or contactless I/C chip 80 embedded therein. Information can be read from or stored on or saved to the chip 80. Two types of pouches are associated with this device; one comes with a sticky flap for enclosing the card in the pouch by hand and one is manufactured optimally for use with a melting process.

FIG. 4 shows a side view of the traditional trading card chipper 70. The chipper 70 includes a chipper housing 82 having an upper portion 84 slidingly mounted to and biased away from a lower portion 86. A tray slot 88 is located between and formed by the upper portion 84 and the lower portion 86. A chipper tray 90 is also provided and adapted for insertion into the tray slot 88. A heating pad 91 is located adjacent the slot within the upper portion 84. An interlock switch 89 is also located in the upper portion 84 for preventing operation of the heating pad 91 unless it is engaged.

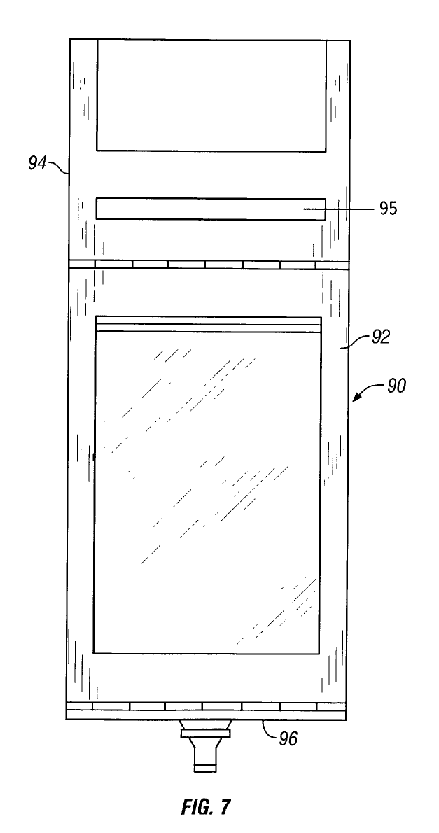

The chipper tray 90 (FIGS. 6-7) includes a base portion 92 and a lid portion 94 hinged to the base portion 92. The chipper tray 90 also includes a locking mechanism 96 also hinged to the base portion 92 and including a projection 98. The lid portion 94 also includes an access window 95 to be described.

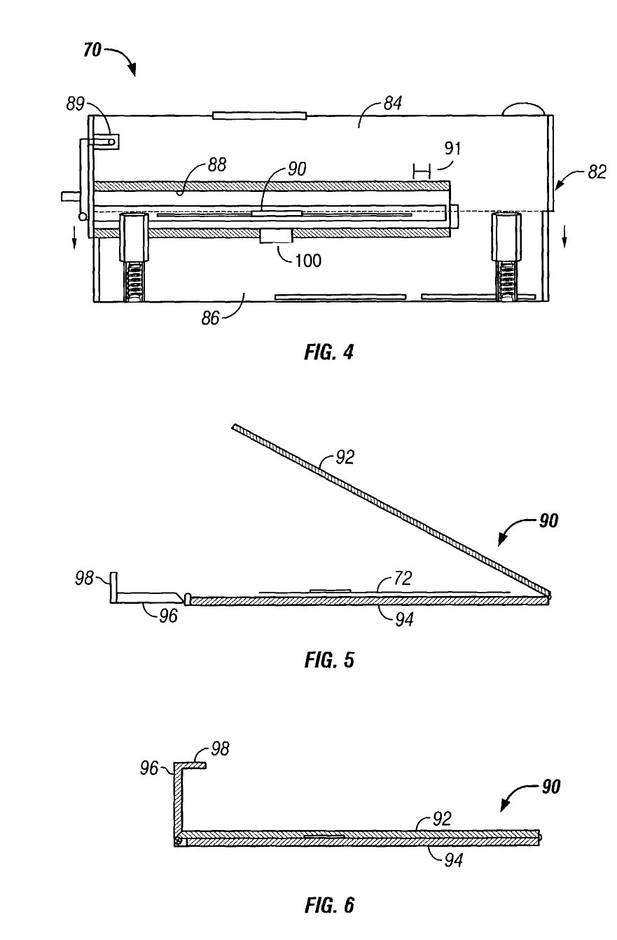

In use, the end user would take a traditional trading card 74 and insert it into a pouch 72 so it is in a position within the pouch 72 as shown in FIG. 8. The card 74 and pouch 72 combination is then placed on the base portion 90 as shown in FIG. 5 and the lid portion 92 closed as shown in FIG. 6. The locking mechanism 94 is then moved to the position also shown in FIG. 6. The tray 90 is then inserted into the tray slot 88 as shown in FIG. 4. The projection engages the interlock switch 89. Then the user pushes down on the upper portion 84 of the housing 82 causing it to slide towards the lower portion 86. A position sensor 100 detects the relative position of the upper portion 84 with respect to the lower portion 86 and activates the heating pad 91 when it is immediately adjacent the pouch 72. The heating pad 91 is positioned within the upper portion 84 so as to be located near the top edge 79 of the pouch 72 when the tray 90 containing the pouch 72 is inserted into the tray slot 88. The heating pad 91 is also positioned to pass through the access window 95 to contact the pouch 72. The heating pad 91 seals the top edge 79 to permanently enclose the traditional trading card 74 within the pouch 72 and to permanently associate the trading card 74 with the chip 80.

Once the top edge 79 has been sealed, the tray 90 may be removed from the chipper 70, and the pouch 72 removed from the tray 90. From this point, the pouch 72 and card 74 combination may be inserted into the scanner/reader device 12 previously described in a manner previously described. The functioning of the scanner/reader device 12 will be the same for the pouch 72/card 74 combination as previously described, except in one respect. The chip 80 provided with the pouch 72 by the manufacturer will originally be void of any card specific information. The chipper reader 52 will recognize this and communicate same to the logic board 44. The logic board 44 will then control the reader 52 to save on the chip 80, card specific information detected by the scanner 50 and communicated to the logic board 44. Once this has occurred, the traditional trading card 74 without a computer readable medium 22, has been digitized and may be utilized or played in the virtual world in a manner previously described in connection with improved trading card 10.

An additional application of the reader/scanner device 12 is in connection with a security system. The system would comprise a security card 102 (FIG. 9) and the reader/scanner device 12 (FIG. 2). The security card 102 includes a photograph 104 of an individual, and an integrated computer chip 106, such as a smart chip. Stored on the chip 106 is authorization and identification information. The stored identification information would include digital information corresponding to the photograph 104. Before the individual depicted in the photograph 104 is given access to a restricted area (for example), the security card 102 is inserted into the scanner/reader device 12. The photograph 104 is optically scanned by the scanner 50 which is converted to digital data by software stored on the logic board 44. The converted digital data is compared by the logic board 44 to the digital information stored on the chip 106 corresponding to the photograph 104. If the two sets of digital information are identical, according to predetermined criteria previously stored on the logic board 44, the scanner/reader device 12 outputs a visual or other signal, such as illuminating a green light that may be provided with the device 12. If the information does not match, a red light provided with the device 12 may be illuminated. Of course, no light need be illuminated, rather the results of the comparison may be transmitted via known means to centralized computer, database or other device for further processing. Furthermore, the security aspect of the scanner/reader device may include the use of the following methods of verification such as watermarking, area capture, photo recognition, or backup.

Watermarking is the act of printing a logo such as characters or image as part of the printed photo of the individual card holder. This watermark(s) can be hidden in the photo in such a way that it is difficult for an individual to reproduce.

Area capture works in such a way that certain areas of the photo are digitally stored in the integrated chip or database in fine detail, and these areas alone or in particular are scanned. This maintains high security while improving scanning and processing speed. For example, the scanner might scan only the area around the left eye and the mouth of the individual one day, but the beard/chin and hair the next day.

Photo recognition works in similar ways to facial recognition of live humans except that this method uses a scanner instead of a camera and is more accurate because the original (stored on the database and/or smart card) and the printed photo have exactly the same data and include not only faces but clothes and background as well. Certain parts of the face, torso, background, watermark and so on are measured for height and length and then they are measured again for distance in height and length from each other. Therefore the distance from the bottom of the nose to the top of the blouse is measured in cm, pixels, or other measurement method and this is compared to the exact data stored on the integrated chip or database. The result of the comparison is more accurate than facial recognition software and the results are shown accordingly.

Backup uses one or more of the above described methods to work as a backup system for biometric or other security systems. In cases where the input tool or even database for a biometric security system is unavailable due to loss of power, sabotage, network malfunction, overcrowding, and so on, this device can act as a handy and handheld backup security system. By storing the photo image data on the chip as well as on a database, security personnel can easily identify if A) the photo, B) the chip, or C) the database has been invalidated, corrupted, or tampered with in any way. Also, if a secure ID card's smart chip is damaged, the photo image data can be matched to existing data on the server to verify authenticity before providing the user with a new secure ID card.

It is noted that the chip 106 may include any of the well known multi-megabyte chips or those in development that can perform functions and run programs internally and/or contact-less chips that can be read and scanned on the fly. The scanner/reader device 12 could also be used to verify next generation monetary bills, bank notes, personal checks that will include embedded chips to verify their authenticity.

It will be understood that the invention may be embodied in other specific forms without departing from the spirit or central characteristics thereof. The present example and embodiments, therefore, are to be considered in all respects as illustrative and not restrictive, and the invention is not to be limited to the details given herein.

1. A method of playing a trading card game comprising the steps of:
collecting a deck of trading cards, each trading card comprising a performance parameter;
selecting a hand of trading cards from the deck;
inputting the performance parameter of each trading card of the hand to a personal computing device; and
playing the trading card game on the personal computing device utilizing the inputted performance parameter.

2. The method of claim 1 wherein the personal computing device is capable of communication with a second personal computing device for the purpose of playing the trading card game.

3. The method of claim 1 wherein the personal computing device is capable of communication over a computer network for playing the trading card game.

4. The method of claim 1 wherein the performance parameter is stored on a computer readable medium located on the trading card.

5. The method claim 4 wherein the step of inputting the performance parameter of each trading card of the hand to a personal computing device is performed utilizing a trading card scanner/reader device.

6. The method of claim 5 wherein the trading card scanner/reader device comprises:
an optical scanning assembly operably connected to a logic board for optically scanning printed information on the trading card; and
a computer chip reading assembly operably connected to the logic board for reading the computer readable medium and for writing to the computer readable medium;
wherein software stored on the logic board compares the information scanned by the scanning unit to the information read by the smart chip reading unit.

7. A method comprising the steps of:
manufacturing trading cards according to a plurality of game rules and having a printed data field and a computer readable medium including a performance parameter defined by the plurality of rules;
providing a scanner/reader device for scanning the printed data field and reading the computer readable medium;
wherein the scanner/reader device permits a player to play the trading card game using a personal computing device, according to the performance parameter read from the computer readable medium.

8. The method of claim 7 further comprising the step of distributing the trading cards.

9. The method of claim 7 further comprising the step of distributing the scanner/reader device.

10. The method of claim 7 further comprising the step of publishing the plurality of rules.

11. The method of claim 7 wherein the scanner/reader device comprises:
an optical scanning assembly operably connected to a logic board for optically scanning printed information on the trading card; and
a computer reading assembly operably connected to the logic board for reading the computer readable medium;
wherein software stored on the logic board compares the information scanned by the scanning unit to the information read by the chip reading assembly.

12. The method of claim 7 further comprising the step of developing the plurality of rules.

13. A system for enabling a traditional trading card game trading card to be digitized, the system comprising:
a chip strip comprising:
a transparent plastic covering; and
an integrated circuit embedded in the transparent covering capable of having data stored thereon and read therefrom;
wherein the transparent covering is sized and shaped to sealingly enclose a trading card; and
a card chipper adapted to seal the trading card within the chip strip thereby permanently associating the trading card with the integrated circuit.

14. The system of claim 13 wherein the integrated circuit is a contact-less chip.

15. The system of claim 13 wherein the integrated circuit is a static memory device.

16. The system of claim 13 wherein the card chipper comprises:
a housing having a slot for receiving a chip strip tray; and
a heating pad adjacent the slot for sealing the transparent covering.

17. The system of claim 16 wherein the housing comprises:
an interlock safety for activating the heating pad, the interlock safety being engaged by a protrusion on the chip strip tray upon insertion of the tray into the slot.

18. The system of claim 16 wherein the housing further comprises:
an upper portion slidingly mounted on a lower portion; and
a switch for activating the heating pad;
wherein the switch is operated when upper portion slides toward the lower portion.

19. A method of digitizing a traditional trading card comprising a printed data field containing card identification information and performance parameter information, the method comprising the steps of:
associating the traditional trading card with a contact-less integrated circuit computer chip; and
scanning the identification and performance parameter information from the card and saving the scanned information to the computer chip.

20. The method of claim 19 wherein the step of associating the card with the chip is performed by a trading card chipper comprising:
a housing having a slot for receiving a chip strip tray; and
a heating pad adjacent the slot for sealing the transparent covering.

21. The method of claim 19 wherein the step of scanning and saving is performed by a scanner/reader device comprising:
an optical scanning assembly operably connected to a logic board for optically scanning printed information on the trading card; and
a computer reading assembly operably connected to the logic board for reading the computer readable medium;
wherein software stored on the logic board compares the information scanned by the scanning unit to the information read by the chip reading assembly.

22. A scanner/reader device for use with a card having printed information and information stored on a computer readable medium, the device comprising:
a housing having a slot adapted for receiving the card;
a plurality of pressure sensitive guide rollers adjacent the slot;
an optical scanning assembly mounted within the housing for detecting the printed information;
a chip reading assembly mounted within the housing for detecting the information stored on the computer readable medium;
a logic board within the housing for controlling the optical scanning unit and the chip reading unit and the rollers; and
an output port for outputting information detected by the scanner/reader device.

23. The device of claim 22 wherein software stored on the logic board compares the printed information detected by the optical scanning assembly to the information detected by the chip reading assembly and outputs a signal corresponding to the result of the comparison.

24. The device of claim 22 wherein the card is a trading game card and the printed information includes card identifying information and performance parameter information and the information stored in the computer readable medium includes card identifying information and performance parameter information.

25. The device of claim 22 wherein the card is a security identification card and the printed information includes a user's photograph and the information stored on the computer readable medium includes card authorization information and information corresponding to the photograph of the card's authorized user.

26. A security system comprising:
a smart card comprising a photograph of an authorized user and a smart chip having security authorization information stored thereon and having the digital equivalent of part or all of the photograph of the authorized user stored thereon;
a scanner/reader device for optically scanning the photograph and converting the photograph to a digital file and for reading the information stored on the smart chip;
wherein the scanner/reader device compares the digital file to the digital equivalent of the photograph of the authorized user and outputs the results of the comparison.

27. The system of claim 26 wherein the scanner/reader comprises:
a housing having a slot adapted for receiving the card;
a plurality of pressure sensitive guide rollers adjacent the slot;
an optical scanning assembly mounted within the housing for scanning the photograph;
a chip reading assembly mounted within the housing for detecting the information stored on the computer readable medium;
a logic board within the housing for controlling the rollers, the optical scanning unit and the chip reading unit; and
an output means;
wherein software stored on the logic board converts the information scanned by the scanner to a digital file, compare the digital file to the digital equivalent and outputs the results of the comparison.

28. The system of claim 26 wherein the scanner/reader device takes the form of a portable version in communication with a computer network.

29. The system of claim 26 wherein the scanner/reader device takes the form of a standalone portable version.

30. The system of claim 26 wherein the scanner/reader device takes the form of a standalone stationary version.

31. A security system comprising:
a smart card comprising a photograph of an authorized user and a smart chip having security authorization information stored thereon and having the digital equivalent of part or all of the photograph of the authorized user stored thereon;
a scanner/reader device for optically scanning the photograph and converting the photograph to a digital file and for reading the information stored on the smart chip;
wherein the scanner/reader device compares the digital file to data stored on a database.
